(19) United States
(12) Patent Application Publication
(10) Pub. No.: US 2026/0063655 A1
(43) Pub. Date: Mar. 5, 2026

(54) FULLY AUTOMATED SAMPLE PREPARATION SYSTEM AND METHODS

(71) Applicant: Cura Diagnostics Inc., Woburn, MA (US)

(72) Inventors: Qian Cheng, Woburn, MA (US); Jia He, Woburn, MA (US)

(21) Appl. No.: 19/311,776

(22) Filed: Aug. 27, 2025

Related U.S. Application Data
(60) Provisional application No. 63/690,072, filed on Sep. 3, 2024.

(51) Int. Cl. G01N 35/10; G01N 35/00

(52) U.S. Cl. CPC G01N 35/1065; G01N 35/00732; G01N 2035/00752; G01N 2035/103

(57) ABSTRACT

The invention provides a novel system and improved method for liquid sample preparation and handling. More particularly, the invention relates to a fully automated system and method for sample preparation and handling of biological samples for analysis (e.g., LC/MS/MS analysis).

### PRIORITY CLAIMS AND RELATED APPLICATIONS

This application claims the benefit of priority to U.S. Provisional Application No. 63/690,072, filed Sep. 3, 2024, the entire content of which is incorporated herein by reference for all purposes.

### TECHNICAL FIELD OF THE INVENTION

The invention generally relates to a novel system and an improved method for liquid sample preparation and handling. More particularly, the invention relates to a system and method for efficient, accurate and fully automated sample preparation and handling of biological samples for analysis (e.g., LC/MS/MS analysis).

### BACKGROUND OF THE INVENTION

There is a rapidly increasing and evolving need for testing and diagnosis of Drugs-of-Abuse (DOA) and infectious diseases in the past decade. Clinical and laboratory operators continue to endure heavy burdens resulting in significantly reduced turnaround times and increased errors.

Traditional machines and methods that handle biological samples suffer from various shortcomings. For example, they require manual pre-removal and marking of caps of sample tubes, which is a time-consuming step prone to operator errors. Another error source in traditional machines is the issue of random droplet carryover during sampling, a feature resulting from the design of the handling procedure, which decreases sample integrity. Traditional machines with fixed-angle barcode scanners can also be unreliable due to the limited coverage of the tube surface. Furthermore, the traditional machines often require frequent and expensive maintenance.

Therefore, an urgent need remains for improved sample preparation system and method that effectively address these issues.

### SUMMARY OF THE INVENTION

The invention provides an improved sample preparation system and method. The system disclosed herein supports direct loading of primary sealed tubes, thus reducing human errors by eliminating a time-consuming manual step. The disclosed system also features a drop tray to prevent random droplet carryover during sampling, thereby ensuring sample integrity. The system is further equipped with 360° scanning capability which improves system reliability and ease of use. Furthermore, the disclosed system allows users to easily create or modify testing protocols, akin to using a smartphone. This reduces the risk of errors and makes the system accessible to users less familiar with complex programming.

In one aspect, the invention generally relates to an automated liquid sample preparation system, comprising: (a) a set of two or more grippers, each is capable of gripping, de-capping and re-capping a respective sample tube; (b) a set of two or more barcode readers arranged to read a respective barcode and/or reference information labeled on a respective sample tube; (c) a set of two or more pipettors arranged to extract a respective liquid sample from a respective de-capped sample tube; (d) a plurality of sample analysis wells, or a plate comprising the same, for receiving the respective pipetted liquid samples; and (e) a control unit comprising an operating system and user interface allowing automated manipulation of the above.

In another aspect, the invention generally relates to a method for automated high-throughput liquid sample preparation, comprising performing the following steps in dual or multiplexed mode: (1) retrieving two or more capped sample tubes, each sample tube being labeled thereon with a respective barcode and/or reference information and comprising a respective liquid sample therein; (2) scanning the two or more capped sample tubes to read the two or more respective barcodes and/or reference information thereon; (3) de-capping the two or more capped sample tubes to allow access to the two or more respective liquid samples therein; (4) pipetting from the two or more liquid samples to transfer an aliquot thereof respectively to two or more analysis wells as prepared samples for further use; (5) re-capping the two or more sample tubes; and (6) placing the two or more re-capped sample tubes on a sample storage rack.

### BRIEF DESCRIPTION OF THE DRAWINGS

FIG. 1 is an illustrative diagram showing an exemplary embodiment of the automated liquid sample preparation system according to the disclosed invention.

FIG. 2 shows a frontal image of an exemplary unit of Xpeedy™ A20 (Cura Diagnostics, Woburn, MA).

### DEFINITIONS

Ranges provided herein are understood to be shorthand for all of the values within the range. For example, a range of 1 to 6 is understood to include any number, combination of numbers, or sub-range from the group consisting 1, 2, 3, 4, 5 or 6.

In this specification and the appended claims, the singular forms “a,” “an,” and “the” include plural reference, unless the context clearly dictates otherwise.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein can be modified by the term about.

Unless specifically stated or obvious from context, as used herein, the term “or” is understood to be inclusive.

Any compositions or methods disclosed herein can be combined with one or more of any of the other compositions and methods provided herein.

The term “comprising”, when used to define compositions and methods, is intended to mean that the compositions and methods include the recited elements, but do not exclude other elements. The term “consisting essentially of”, when used to define compositions and methods, shall mean that the compositions and methods include the recited elements and exclude other elements of any essential significance to the compositions and methods. For example, “consisting essentially of” refers to administration of the pharmacologically active agents expressly recited and excludes pharmacologically active agents not expressly recited. The term consisting essentially of does not exclude pharmacologically inactive or inert agents, e.g., pharmaceutically acceptable excipients, carriers or diluents. The term “consisting of”, when used to define compositions and methods, shall mean excluding trace elements of other ingredients and substantial method steps. Embodiments defined by each of these transition terms are within the scope of this invention.

### DETAILED DESCRIPTION OF THE INVENTION

The invention provides a sample preparation system and method that enables fully automated preparation of liquid samples including direct loading of primary sealed tubes, built-in 360° barcode reader, dual-arm system with 2-channel de-capping and pipetting capabilities, and precision sample and reagent transfer. The entire process, from sample preparation to plate readiness for LC/MS/MS, is fully automated.

In an exemplary system of the disclosed invention, the Xpeedy™ A20 system of Cura Diagnostics (Woburn, MA) is equipped with a pair of built-in barcode readers that perform comprehensive scanning of sample information during the de-capping process. The system uses an Android OS with an intuitive and straightforward user interface, rendering the system easier to operate. The Xpeedy™ A20 system minimizes the risk of sample carryover by significantly reduced open vial period. An innovative drop-tray design further prevents cross-contamination during pipetting. In addition, the system uses a pneumatic pipetting system with a range of 1 to 1,000 microliters accommodating a wide range of usage scenarios. The use of high precision servo motors further guarantees accurate positioning and reliable automation. Overall, the innovative design of the Xpeedy™ A20 system addresses common issues in the currently available products, providing a robust and dependable solution for a broad range of applications.

In one aspect, the invention generally relates to an automated liquid sample preparation system, comprising:
(a) a set of two or more grippers, each is capable of gripping, de-capping and re-capping a respective sample tube;
(b) a set of two or more barcode readers arranged to read a respective barcode and/or reference information labeled on a respective sample tube;
(c) a set of two or more pipettors arranged to extract a respective liquid sample from a respective de-capped sample tube;
(d) a plurality of sample analysis wells, or a plate comprising the same, for receiving the respective pipetted liquid samples; and
(e) a control unit comprising an operating system and user interface allowing automated manipulation of the above.

In certain embodiments, the system further comprises:
(f) one or more storage racks for storing sample tubes;
(g) an area for storing clean pipette tips;
(h) a storage for replacement caps;
(i) one or more waste disposal areas; and/or
(j) a reagent storage area;
(k) a heating and/or air controlling module;
(l) a monitor or touch screen for operating the control unit; and/or
(m) an emergency stops switch or button.

In certain embodiments, the system further comprises:
(n) a casing or frame for housing one or more of (a)-(m).

In certain embodiments, each of the set of two or more grippers is capable of rotating the respective sample tube to allow 360° scanning by the respective barcode scanner.

In certain embodiments, each pipettor is equipped with a dripping tray for catching unintended dropping from pipettors in transit.

In certain embodiments, the two or more grippers are suited for gripping, de-capping and re-capping sample tubes having an exterior diameter of about 12.5 mm to about 16.5 mm and an exterior length of about 8.5 cm to about 12.0 cm.

In certain embodiments, the two or more pipettors are capable of extracting a liquid volume between about 20 μL to about 1,000 μL (e.g., about 20 μL to about 500 μL, about 20 μL to about 100 μL, about 100 μL to about 1,000 μL).

In certain embodiments, the operating system and user interface allow fully automated processing based on specific protocols.

In another aspect, the invention generally relates to a method for automated high-throughput liquid sample preparation, comprising performing the following steps in dual or multiplexed mode:
(1) retrieving two or more capped sample tubes, each sample tube being labeled thereon with a respective barcode and/or reference information and comprising a respective liquid sample therein;
(2) scanning the two or more capped sample tubes to read the two or more respective barcodes and/or reference information thereon;
(3) de-capping the two or more capped sample tubes to allow access to the two or more respective liquid samples therein;
(4) pipetting from the two or more liquid samples to transfer an aliquot thereof respectively to two or more analysis wells as prepared samples for further use;
(5) re-capping the two or more sample tubes; and
(6) placing the two or more re-capped sample tubes on a sample storage rack.

In certain embodiments of the method, two sample tubes are handled in each instance.

In certain embodiments of the method, three or more sample tubes are handled in each instance.

In certain embodiments of the method, the liquid samples are urine samples.

In certain embodiments of the method, the barcode and/or reference information labeled on a sample tube refers to the source of the sample.

In certain embodiments of the method, the pipettes used in (4) are disposed of as waste after each use.

In certain embodiments of the method, the caps used in (5) are replacement caps.

In certain embodiments of the method, the replacement caps are screw caps.

In certain embodiments of the method, the sample tubes are glass tubes.

In certain embodiments of the method, the sample tubes are plastic tubes.

In certain embodiments of the method, about 1 to about 96 (e.g., about 1 to about 12, about 12 to about 48, about 48 to about 96) sample tubes are processed in 60 minutes (unit time).

In certain embodiments, the method is controlled via an operating system and user interface allowing fully automated processing according to specific protocols.

In certain embodiments of the method, the prepared samples are suitable for LC-MS analysis for presence and/or quality of pre-selected chemical agents.

In certain embodiments, the method further comprises: (7) performing liquid chromatography-mass spectrometry (LC-MS) analysis on the prepared samples in respective analysis wells.

In certain embodiments of the method, the LC-MS results are stored and retrievable according to the source of the respective sample.

The following examples are meant to be illustrative of the practice of the invention, and not limiting in any way.

### EXAMPLES

### Xpeedy™ A20: Advanced Automated Sample Preparation for Triple Quadrupole LC/MS/MS Analysis

The Xpeedy™ A20 (Cura Diagnostics Inc., Woburn, MA) is a cutting-edge, fully automatic sample preparation platform designed for Triple Quadrupole LC/MS/MS analysis, specifically tailored for the clinical drug-of-abuse diagnostic field. Its mission is to alleviate the daily burdens of operators and significantly reduce turnaround times (TAT) for laboratories.

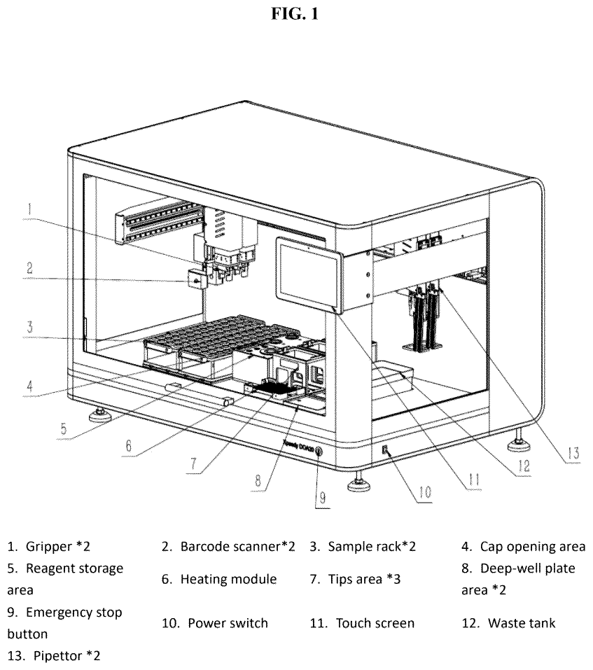

FIG. 1 is an illustrative diagram showing the major components of Xpeedy™ A20 system.

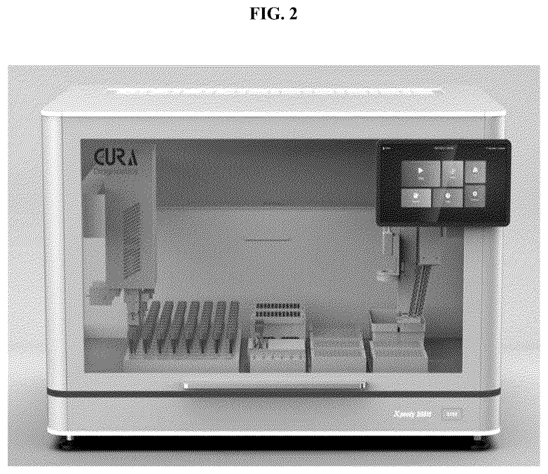

A picture of an exemplary unit of Xpeedy™ A20 is shown in FIG. 2.

A video clip that demonstrates the operation of the Xpeedy™ A20 system is available at: https://www.youtube.com/watch?v=mgbp9hyjpDM (accessed Aug. 18, 2024), which is incorporated herein by reference in its entirety.

### Key Features and Improvements

Fully Automated Sample Preparation Process: Upon loading primary sample tubes, barcode information is instantly collected by a 360° barcode reader. The unique dual-arm system, comprising decappers and a 2-channel pipettor, ensures precise sample and reagent transfer based on specific protocols. The entire process, from sample preparation to plate readiness for LC/MS/MS, is fully automated.

Simplified Protocol Creation/Modification: The Xpeedy™ A20 is equipped with an Android OS, providing an intuitive and straightforward user interface. This makes the system easier to operate compared to prior art platforms. The graphical programming function of the Xpeedy™ A20 allows users to create or modify testing protocols easily, akin to using a smartphone. This reduces the risk of errors and makes the system accessible even to those less familiar with complex programming.

Primary Tube Loading: Unlike traditional machines that require pre-removal and marking of caps, the Xpeedy™ A20 supports direct loading of primary sealed tubes, eliminating time-consuming manual steps and reducing errors.

360° Barcode Scanning: The built-in barcode readers perform comprehensive scanning of sample information during the de-capping process, ensuring efficiency and accuracy. Traditional fixed-angle barcode scanners can be unreliable. The Xpeedy™ A20's 360° scanning capability resolves this issue by reading barcodes while twisting, improving reliability and ease of use.

No Carryover: The Xpeedy™ A20 features a drop tray to prevent random droplet carryover during sampling, ensuring sample integrity. Utilizing disposable consumables and a smart de-capping mechanism, the Xpeedy™ A20 minimizes the open vial period, significantly reducing the risk of sample carryover. The innovative drop-tray design further prevents cross-contamination during pipetting.

High Precision: The pneumatic pipetting system, with a range of 1 to 1,000 microliters, caters to various usage scenarios in clinical laboratories. The use of high precision servo motors guarantees accurate positioning and reliable automation.

Reduced Maintenance: The Xpeedy™ A20 is designed with advanced integrated technology, requiring less frequent and less expensive maintenance. Routine maintenance can be performed by normally trained personnel, while only critical components necessitate specialized attention.

Thus, the disclosed invention as represented by the Xpeedy™ A20 system signifies a significant advancement in automated sample preparation for LC/MS/MS analysis, offering enhanced efficiency, upgraded reliability, and improved user experience.

Applicant's disclosure is described herein in preferred embodiments with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of Applicant's disclosure may be combined in any suitable manner in one or more embodiments. In the description, herein, numerous specific details are recited to provide a thorough understanding of embodiments of the invention. One skilled in the relevant art will recognize, however, that Applicant's composition and/or method may be practiced without one or more of the specific details, or with other methods, components, materials, and so forth. In other instances, well-known structures, materials, or operations are not shown or described in detail to avoid obscuring aspects of the disclosure.

Unless defined otherwise, all technical and scientific terms used herein have the same meaning as commonly understood by one of ordinary skill in the art. Although any methods and materials similar or equivalent to those described herein can also be used in the practice or testing of the present disclosure, the preferred methods and materials are now described. Methods recited herein may be carried out in any order that is logically possible, in addition to a particular order disclosed.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

### Equivalents

The representative examples are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples and the references to the scientific and patent literature included herein. The examples contain important additional information, exemplification and guidance that can be adapted to the practice of this invention in its various embodiments and equivalents thereof.

What is claimed is:

1. An automated liquid sample preparation system, comprising:
(a) a set of two or more grippers, each is capable of gripping, de-capping and re-capping a respective sample tube;
(b) a set of two or more barcode readers arranged to read a respective barcode and/or reference information labeled on a respective sample tube;
(c) a set of two or more pipettors arranged to extract a respective liquid sample from a respective de-capped sample tube;
(d) a plurality of sample analysis wells, or a plate comprising the same, for receiving the respective pipetted liquid samples; and
(e) a control unit comprising an operating system and user interface allowing automated manipulation of the above.

2. The system of claim 1, further comprising:
(f) one or more storage racks for storing sample tubes;
(g) an area for storing clean pipette tips;
(h) a storage for replacement caps;
(i) one or more waste disposal areas; and/or
(j) a reagent storage area.

3. The system of claim 1 or 2, further comprising:
(k) a heating and/or air controlling module.

4. The system of any one of claims 1-3, further comprising:
(l) a monitor or touch screen for operating the control unit; and/or
(m) an emergency stops switch or button.

5. The system of claim 4, further comprising:
(n) a casing or frame for housing one or more of (a)-(m).

6. The system of any one of claims 1-5, wherein each of the set of two or more grippers is capable of rotating the respective sample tube to allow 360° scanning by the respective barcode scanner.

7. The system of any one of claims 1-6, wherein each pipettor is equipped with a dripping tray for catching unintended dropping from pipettors in transit.

8. The system of any one of claims 1-7, wherein the two or more grippers are suited for gripping, de-capping and re-capping sample tubes having an exterior diameter of about 12.5 mm to about 16.5 mm and an exterior length of about 8.5 cm to about 12.0 cm.

9. The system of any one of claims 1-8, wherein the two or more pipettors are capable of extracting a liquid volume between about 20 μL to about 1,000 μL.

10. The system of any one of claims 1-8, wherein the operating system and user interface allow fully automated processing based on specific protocols.

11. A method for automated high-throughput liquid sample preparation, comprising performing the following steps in dual or multiplexed mode:
(1) retrieving two or more capped sample tubes, each sample tube being labeled thereon with a respective barcode and/or reference information and comprising a respective liquid sample therein;
(2) scanning the two or more capped sample tubes to read the two or more respective barcodes and/or reference information thereon;
(3) de-capping the two or more capped sample tubes to allow access to the two or more respective liquid samples therein;
(4) pipetting from the two or more liquid samples to transfer an aliquot thereof respectively to two or more analysis wells as prepared samples for further use;
(5) re-capping the two or more sample tubes; and
(6) placing the two or more re-capped sample tubes on a sample storage rack.

12. The method of claim 11, wherein two sample tubes are handled in each instance.

13. The method of claim 11, wherein three or more sample tubes are handled in each instance.

14. The method of any one of claims 11-13, wherein the liquid samples are urine samples.

15. The method of any one of claims 11-14, wherein the barcode and/or reference information labeled on a sample tube refers to the source of the sample.

16. The method of any one of claims 11-15, wherein pipettes used in (4) are disposed of as waste after each use.

17. The method of any one of claims 11-15, wherein caps used in (5) are replacement caps.

18. The method of claim 17, wherein the replacement caps are screw caps.

19. The method of any one of claims 11-18, wherein the sample tubes are glass tubes.

20. The method of any one of claims 11-18, wherein the sample tubes are plastic tubes.

21. The method of any one of claims 11-20, wherein about 1 to about 96 sample tubes are processed in 60 minutes (unit time).

22. The method of any one of claims 11-21, wherein the method is controlled via an operating system and user interface allowing fully automated processing according to specific protocols.

23. The method of claim 22, wherein the prepared samples are suitable for LC-MS analysis for presence and/or quality of pre-selected chemical agents.

24. The method of any one of claims 11-23, further comprising:
performing liquid chromatography-mass spectrometry (LC-MS) analysis on the prepared samples in respective analysis wells.

25. The method of claim 24, wherein the LC-MS results are stored and retrievable according to the source of the respective sample.
